(19) United States
(12) Patent Application Publication
(10) Pub. No.: US 2015/0069872 A1
(43) Pub. Date: Mar. 12, 2015

(54) CYLINDRICAL PERMANENT MAGNETIC COUPLING DEVICE

(71) Applicant: Delta Electronics (Shanghai) Co., Ltd., Shanghai (CN)

(72) Inventors: Hong-Liu ZHU, Shanghai (CN); Tsu-Hua AI, Shanghai (CN); Hong-Cheng SHEU, Shanghai (CN)

(21) Appl. No.: 14/449,212

(22) Filed: Aug. 1, 2014

(30) Foreign Application Priority Data
Sep. 6, 2013 (CN) 201310404847.1

(51) Int. Cl. H02K 49/04; H02K 1/02; H02K 1/27

(52) U.S. Cl. CPC H02K 49/043; H02K 1/2793; H02K 1/02; H02K 2201/03; H02K 2213/09
USPC 310/105

(57) ABSTRACT

A cylindrical permanent magnetic coupling device includes a conductor rotor and a permanent magnet rotor. The conductor rotor includes a bottom and a sidewall surrounding the bottom for defining a cavity, in which the cavity includes at least two different inner diameters. The permanent magnet rotor is arranged in the cavity for providing at least two different air gaps between the conductor rotor and the permanent magnet rotor.

### RELATED APPLICATIONS

This application claims priority to China Application Serial Number 201310404847.1, filed Sep. 6, 2013, which is herein incorporated by reference.

### BACKGROUND

1. Field of Invention

The present invention relates to a permanent magnetic coupling device. More particularly, the present invention relates to a cylindrical permanent magnetic coupling device.

2. Description of Related Art

A permanent magnetic coupling device is a transmission device that transmits torque through an air gap. The permanent magnetic coupling device includes a conductor rotor and a permanent magnet rotor. The conductor rotor is fixed on an active shaft and connected to a motor. The permanent magnet rotor is fixed on a load shaft and connected to a load. The air gap is formed between the conductor rotor and the permanent magnet rotor so that the connection between the motor and the load is changed from a mechanical connection to a magnetic connection. By controlling the length or area of the air gap between the permanent magnet rotor and the conductor rotor, the output torque of the load shaft can be changed and thereby the rotational speed of the load can be adjusted.

The permanent magnetic coupling device has the following advantages on actual applications: the drive motor can be actuated without loading, so that the initial current of the motor is decreased, thus prolonging the motor operation life and reducing the effects on a power system; because of transmitting the torque through the air gap, the connection accuracy required between the motor and the load is lowered, and the mechanical vibration and noise are reduced; adopting the permanent magnetic coupling device can achieve the continuous adjustment of flow or pressure, and thus is more energy-saving smaller than adopting a valve or damper.

However, the slip power of the permanent magnetic coupling device is consumed on the conductor rotor, in which the temperature rise is proportional to the power loss, namely, the greater the power loss is, the higher the temperature rise is. When the power loss exceeds a limit value, the conductor rotor will be damaged by overheating, and will be cracked or even melted when serious. In addition, the loss is not evenly distributed on the conductor rotor, and the power loss density at a point of the conductor rotor is correlated with the magnetic density of the point. At the region near the permanent magnet rotor, the power loss goes higher due to the greater magnetic density. Once the local loss of the conductor rotor exceeds a certain value, the hot spots are formed on conductor rotor locally. Even though the overall temperature rise of the conductor rotor does not exceed the limit value, the conductor rotor is still damaged by overheating due to the existence of the hot spots.

The permanent magnetic coupling device can be classified to three types: cylindrical, disk-like and complex types. FIG. 1A and FIG. 1B illustrate cross-sectional schematic diagrams of a conventional cylindrical permanent magnetic coupling device from different view angles. A cylindrical permanent magnetic coupling device 10 includes a conductor rotor 20 connected to a motor and a permanent magnet rotor 30 connected to a load. Once the rotational speed of the permanent magnet rotor 30 needs adjusting, it can be achieved by adjusting the area of an air gap between the conductor rotor 20 and the permanent magnet rotor 30. However, the permanent magnet rotor 30 is substantially enclosed by the conductor rotor 20. Therefore, in the rotational speed area with greater power loss, the thermal dissipation area of the conductor rotor 20 and the air gap are smaller, thus causing the phenomena of temperature rise and local heat damage of the conductor rotor 20 to be more apparent.

### SUMMARY

The present invention provides a cylindrical permanent magnetic coupling which has at least two different air gaps for improving the heat dissipation capability of the cylindrical permanent magnetic coupling. The air gap is a radial distance between the conductor rotor and the permanent magnet rotor.

An aspect of the present invention is to provide a cylindrical permanent magnetic coupling device including a conductor rotor and a permanent magnet rotor. The conductor rotor includes a bottom and a sidewall surrounding the bottom which are defined as a cavity, in which the cavity includes at least a first inner diameter and a second inner diameter other than the first inner diameter. The permanent magnet rotor is arranged in the cavity for providing at least two different air gaps between the conductor rotor and the permanent magnet rotor, wherein the two air gaps are respectively corresponding to the first inner diameter and the second inner diameter.

From the above, the permanent magnetic coupling device of the invention includes more than two kinds of inner diameters, there are more than two air gaps between the conductor rotor and the permanent magnet rotor. When the output of permanent magnetic coupling device is adjusted by changing the relative position between the conductor rotor and the permanent magnet rotor, the air gap there is increased gradually. Therefore, the heat dissipation capacity of the conductor rotor is improved and the force pulling the conductor rotor can be reduced.

### BRIEF DESCRIPTION OF THE DRAWINGS

FIG. 1A and FIG. 1B are cross-sectional schematic diagrams of a conventional cylindrical permanent magnetic coupling device from different view angles;

FIG. 2 is a cross-sectional schematic view of a cylindrical permanent magnetic coupling device according to a first embodiment of the invention;

FIG. 3 is a comparative diagram of axial force of different cylindrical permanent magnetic coupling devices during speed adjustment;

FIG. 4A and FIG. 4B are right-side views of a base and a extending portion of a conductor rotor of an embodiment of the invention, respectively;

FIG. 5 is a cross-sectional schematic view of a cylindrical permanent magnetic coupling device according to a second embodiment of the invention;

FIG. 6 is a cross-sectional schematic view of a cylindrical permanent magnetic coupling device according to a third embodiment of the invention; and

FIG. 7 is a cross-sectional schematic view of a cylindrical permanent magnetic coupling device according to a fourth embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In order to improve the heat dissipation capacity of a cylindrical permanent magnetic coupling device, the present invention provides a cylindrical permanent magnetic coupling device with a changeable air gap between a conductor rotor and a permanent magnet rotor thereof. When the output of the cylindrical permanent magnetic coupling device is adjusted, the air gap between the conductor rotor and the permanent magnet rotor is changed accordingly to improve the heat dissipation capacity of the cylindrical permanent magnetic coupling device.

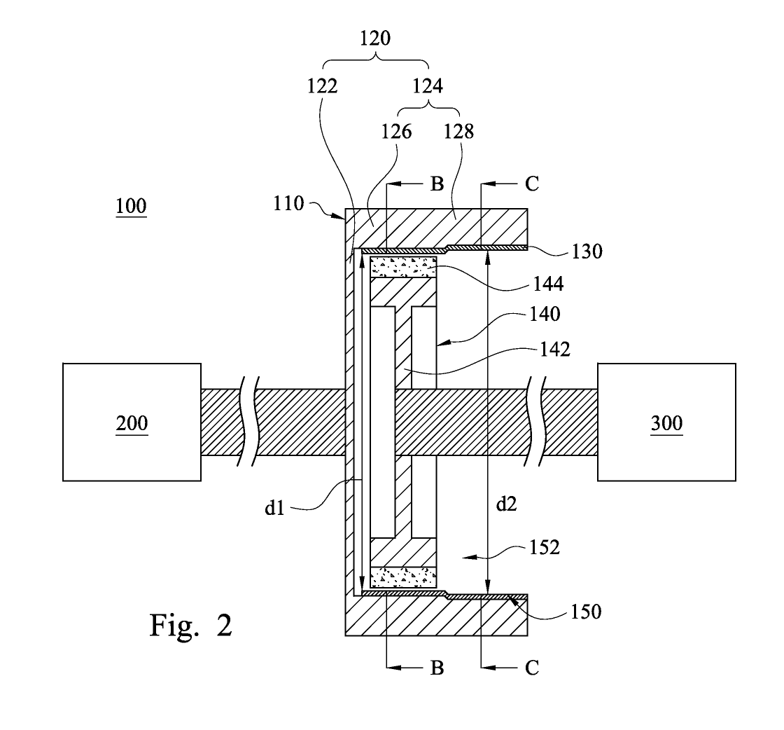

FIG. 2 is a cross-sectional schematic diagram of a cylindrical permanent magnetic coupling device according to a first embodiment of this invention. A cylindrical permanent magnetic coupling device 100 includes a conductor rotor 110 and a permanent magnet rotor 140. The conductor rotor 110 includes a bottom 122 and a sidewall 124 surrounding the bottom 122. A cavity 150 is defined by the bottom 122 and the sidewall 124, and the permanent magnet rotor 140 is disposed in the cavity 150. The cavity 150 includes at least a first inner diameter d1 and a second inner diameter d2 other than the first inner diameter d1 for providing at least two different air gaps between the conductor rotor 110 and the permanent magnet rotor 140, in which the two air gaps are respectively corresponding to the first inner diameter and the second inner diameter. Each of the air gaps between the conductor rotor 110 and permanent magnet rotor 140 is greater than or equal to about 4 mm.

The cavity 150 has an opening 152 for allowing the permanent magnet rotor 140 to be placed in the cavity 150. The opening 152 and the bottom 122 are located at two opposite ends of the sidewall 124. The inner diameter of the cavity 150 near the bottom 122 is regarded as the first inner diameter d1, and the inner diameter of the cavity 150 near the opening 150 is regarded as the second inner diameter d2, in which the first inner diameter d1 is smaller than the second inner diameter d2.

The conductor rotor 110 is connected to a motor 200, and the permanent magnet rotor 140 is connected to a load 300. The torque between both rotors is transmitted by the air gap, and the rotational speed of the permanent magnet rotor 140 is adjusted through the air gap area.

The conductor rotor 110 includes a magnetic cylinder 120 and a conductor ring 130. The magnetic cylinder 120 includes the aforementioned bottom 122 and the sidewall 124. The magnetic cylinder 120 is made of low carbon steel or a silicon steel plate. The conductor ring 130 is made of copper, aluminum or a Fe—Cu alloy.

The sidewall 124 of the magnetic cylinder 120 includes a base 126 and an extending portion 128, and the first inner diameter d1 of the magnetic cylinder 120 at the base 126 is smaller than the second inner diameter d2 of the magnetic cylinder 120 at the extending portion 128. In the present embodiment, axial cross-sectional profiles of the base 126 and the extending portion 128 (parallel to the axial direction) are about rectangles, and the first inner diameter d1 of the magnetic cylinder 120 at the base 126 is smaller than the second inner diameter d2 of the magnetic cylinder 120 at the extending portion 128. Axial lengths of the base 126 and the extending portion 128 are greater than an axial length of the permanent magnet rotor 140 respectively.

A magnetic ring 142 is made of low carbon steel or a silicon steel plate. A plurality of permanent magnets 144 is made of a permanent material, such as Nd—Fe—B. The permanent magnets 144 and the conductor ring 130 are located between the magnetic cylinder 120 and the magnetic ring 142.

The conductor ring 130 at the base 126 is located closer to the permanent magnet rotor 140 than the conductor ring 130 at the extending portion 128. A ratio of the second inner diameter d2 of the conductor ring 130 at the extending portion 128 to the first inner diameter d1 of the conductor ring 130 at the base 126 is between 1.0 to 1.5, i.e., d2/d1 is greater than 1 and smaller than or equal to 1.5. Once the rotational speed of the load needs reducing, the permanent magnet rotor 140 is shifted along the axial direction away from the conductor rotor 110, and the conductor ring 130 is moved from the base 126 to the extending portion 128 so that the axial length of the air gap between the conductor rotor 110 and the permanent magnet rotor 140 is also increased. Meanwhile, the power loss of the conductor ring 130 is increased gradually. However, because two air gaps are used, as the power loss is increased, the axial distance between the conductor rotor 110 and the permanent magnet rotor 140 are also increased. With the increase of the axial distance, the quantity of air flow through the air gap can be increased to carry away more heat, and reduce the temperature increase. On the other hand, because the magnetic density of the conductor rotor 110 is reduced, the local power loss of the conductor rotor 110 is also decreased. Therefore, the temperature at the hottest point of the conductor rotor 110 is lowered, thereby protecting the conductor rotor 110 from overheating locally.

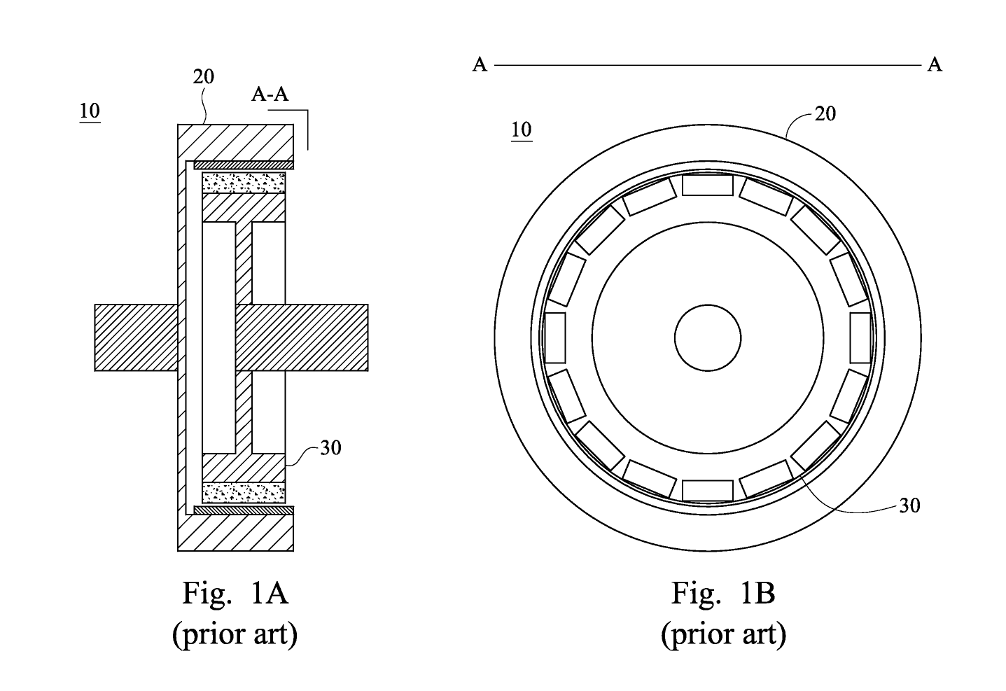

A cylindrical permanent magnetic coupling device (PMD) of which the rated rotational speed is 1500 rpm and the rated power is 300 kW is used as an example. As shown in the FIG. 1, a conductor rotor 20 of the cylindrical permanent magnetic coupling device 10 has an inner diameter of 408 mm and a length of 100 mm. The cylindrical permanent magnetic coupling device 100 having the two air gaps with the same rated power is shown in FIG. 2, in which the first inner diameter d1 of the conductor ring 130 at the base 126 is 408 mm, the second inner diameter d2 of the conductor ring 130 at the extending portion 128 is 416 mm, and a length of the conductor rotor 110 is 200 mm. A permanent magnet rotor 30 of the cylindrical permanent magnetic coupling device 10 is the same as the permanent magnet rotor 140 of the cylindrical permanent magnetic coupling device 100, and the diameters of the rotors are 400 mm. Compared with the conventional cylindrical permanent magnetic coupling device 10, when the conductor power loss is maximum, the length of the air gap in the cylindrical permanent magnetic coupling device 100 with two air gaps is increased once (from 4 mm to 8 mm), the quantity of air flow therein is increased once, the area of heat dissipation therein is increased by 30%, and the maximum local loss is decreased from 734 W/mm² to 514 W/mm², which is decrease by almost 30%.

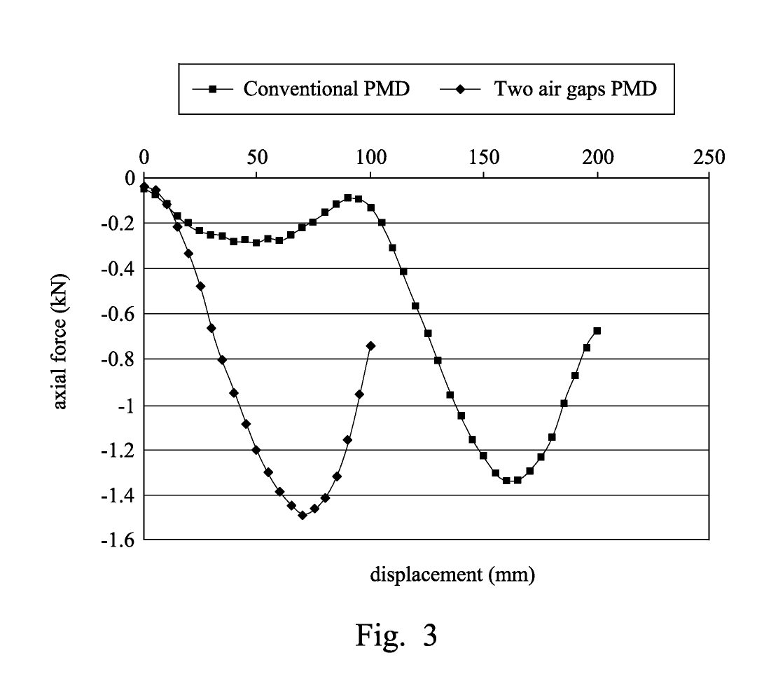

Then, two types of cylindrical permanent magnetic coupling devices 10 and 100 are compared with respect to the required axial force during speed adjustment, and the result is shown in FIG. 3. When the permanent magnet rotors 30 and 140 are fully coupled with the conductor rotors 20 and 110 respectively, the rotational speeds thereof reach the maximum, and displacements corresponding to a horizontal coordinate are about 0. When the permanent magnet rotors 30 and 140 are pulled out of the conductor rotors 20 and 110 respectively, the rotational speeds of respective loads are about 0. Meanwhile, the displacement of the conventional cylindrical permanent magnetic coupling 10 device is 100 mm, and the displacement of the cylindrical permanent magnetic coupling device 100 with two air gaps is 200 mm. Within the speed adjustment range, the maximum axial force of the conventional cylindrical permanent magnetic coupling device 10 is 1.48 kN, and the maximum axial force of the cylindrical permanent magnetic coupling device 100 with two air gaps is 1.33 kN. Therefore, compared with the axial force required for pulling the conductor rotor 20 out of the conventional cylindrical permanent magnetic coupling device 10, the axial force required for pulling the conductor rotor 110 out of the cylindrical permanent magnetic coupling device 100 with two air gaps is decreased by 8.5%. Thus, during the speed adjustment of the cylindrical permanent magnetic coupling device 100 with two air gaps, because the axial force required by a load axis is smaller, the force outputted from the execution mechanism (not shown in the figure) can be reduced, thus shrinking the volume of the mechanism smaller and lowering the cost.

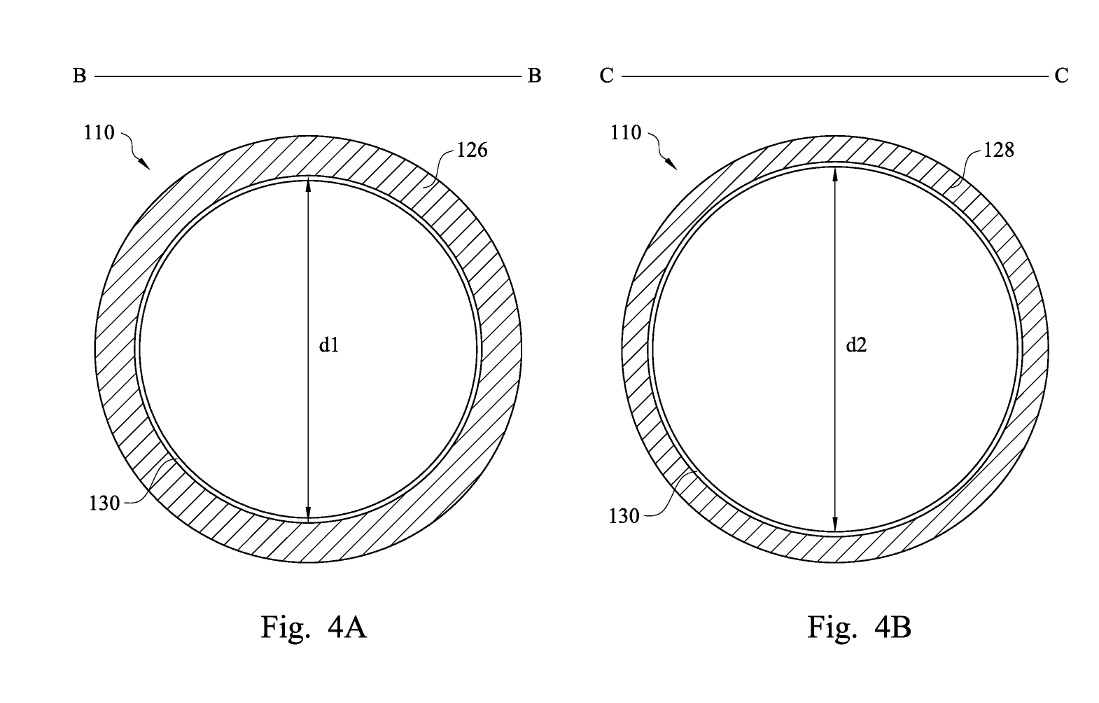

FIG. 4A and FIG. 4B are right-side views of the base 126 and the extending portion 128 of the conductor rotor 110. The figures show the first inner diameter d1 of the conductor rotor 110 at the base 126 is smaller than the second inner diameter d2 of the conductor rotor 110 at the extending portion 128. The conductor ring 130 is located on the inner surfaces of the base 126 and the extending portion 128.

Reference is made back to FIG. 2, the cylindrical permanent magnetic coupling device 100 of the present invention can provide more than two air gaps (i.e. the radial distance between the permanent magnets 144 and the conductor ring 130). As the power loss of the rotor increases, the air gaps are also increased to provide the better heat dissipation capacity and reduce the temperature rise of the conductor rotor 110.

The principle regarding how to decrease the temperature rise of the conductor rotor 110 by the cylindrical permanent magnetic coupling device is described in the aforementioned embodiments. In the following embodiments, the variations of the conductor rotor 110 are explained, and the same descriptions explained in the aforementioned embodiments are not stated again.

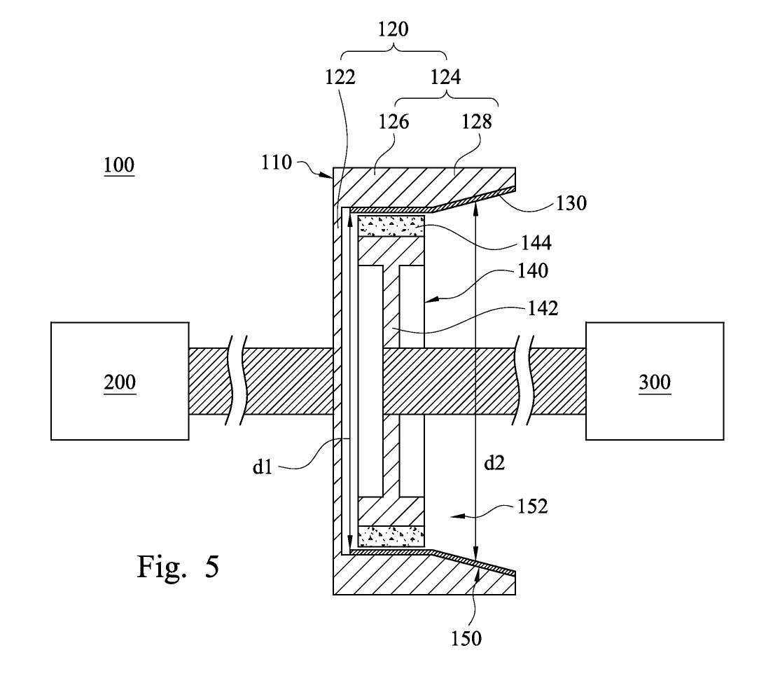

FIG. 5 is a cross-sectional schematic diagram of a cylindrical permanent magnetic coupling device according to a second embodiment of this invention. A cylindrical permanent magnetic coupling device 100 includes a conductor rotor 110 and a permanent magnet rotor 140. The conductor rotor 110 has a cavity 150, and the permanent magnet rotor 140 is located in the cavity 150. The cavity 150 includes at least two different inner diameters for providing at least two different air gaps between the conductor rotor 110 and the permanent magnet rotor 140.

The conductor rotor 110 is connected to a motor 200, and the conductor rotor 110 includes a magnetic cylinder 120 and a conductor ring 130 arranged on an inner surface of the magnetic cylinder 120. The permanent magnet rotor 140 is connected to the load 300, and the permanent magnet rotor 140 includes a magnetic ring 142 and a plurality of permanent magnets 144 arranged on the side of the magnetic ring 142.

A sidewall 124 includes a base 126 and an extending portion 128, in which the base 126 is near the bottom 122, and the extending portion 128 is connected to the base 126. In the present embodiment, an axial cross-sectional profile of the base 126 is a rectangle, and an axial cross-sectional profile of the extending portion 128 is a trapezoid with the width which is gradually decreased in the direction from an end near the base 126 to an opposite end, such that a second inner diameter d2 of the cavity 150 near the opening 152 is greater than a first inner diameter d1 of the cavity 150 near the bottom 122. The second inner diameter d2 of the extending portion 128 is increased gradually in the direction from the base 126 to the extending portion 128.

Axial lengths of the base 126 and the extending portion 128 are greater than the axial length of the permanent magnet rotor 140 respectively.

The principles of improving the heat dissipation capacity and reducing the axial force required for pulling out the conductor rotor 110 by providing the different widths of the air gaps in accordance with different loads are the same as those described in the first embodiment.

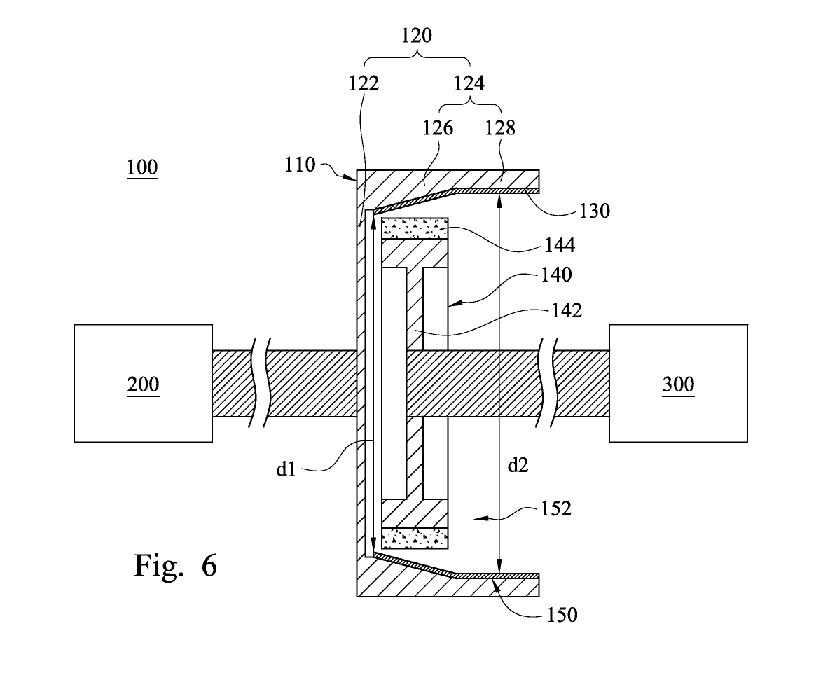

FIG. 6 is a cross-sectional schematic diagram of a cylindrical permanent magnetic coupling device according to a third embodiment of this invention. A sidewall 124 of the magnetic cylinder 120 includes a base 126 and a extending portion 128, and a first inner diameter d1 of a base 126 of the magnetic cylinder 120 is smaller than a second inner diameter d2 of an extending portion 128 of the magnetic cylinder 120. In the present embodiment, in particular, an axial cross-sectional profile of the base 126 is a trapezoid with a width which is decreased gradually in the direction from an end near the bottom 122 to an opposite end, and an axial cross-sectional profile of the extending portion 128 is a rectangle, such that an inner diameter of the cavity 150 near the opening 152 is greater than an inner diameter of the cavity 150 near the bottom 122. The first inner diameter d1 of the base 126 is increased gradually in the direction from the base 122 to the opening 152.

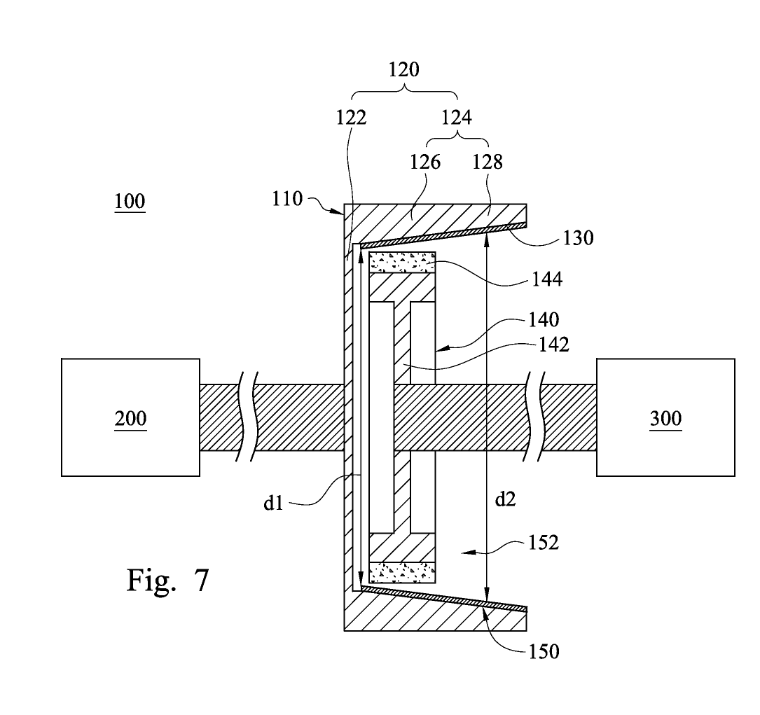

FIG. 7 is a cross-sectional schematic diagram of a cylindrical permanent magnetic coupling device according to a fourth embodiment of this invention.

The present embodiment is different from the aforementioned embodiment in that an axial cross-sectional profile of a sidewall 124 of a magnetic cylinder 120 is a trapezoid, such that an axial cross-sectional profile of a cavity 150 is also a trapezoid, in which, in particular, an inner side is narrower and an outer side is wider. A first inner diameter d1 of the magnetic cylinder 120 near a bottom 122 is smaller than a second inner diameter d2 of the magnetic cylinder 120 near an opening 152. In other words, the present embodiment can be seen as a variation of a base 126 and an extending portion 128 which are trapezoids.

According to the foregoing embodiments, the drive conductor rotor of the cylindrical permanent magnetic coupling device has two or more inner diameters, such that there are two or more air gaps between the conductor rotor and the permanent magnet rotor. When the output is adjusted by changing the relative position between the conductor rotor and the permanent magnet rotor, the air gap between them is increased gradually to improve the heat dissipation capacity of the conductor rotor, and the force pulling the conductor rotor can be reduced.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A cylindrical permanent magnetic coupling device, comprising:
a conductor rotor comprising a bottom and a sidewall surrounding the bottom which are defined as a cavity, wherein the cavity has at least a first inner diameter and a second inner diameter other than the first inner diameter; and
a permanent magnet rotor arranged in the cavity for providing at least two different air gaps between the conductor rotor and the permanent magnet rotor, wherein the two air gaps are respectively corresponding to the first inner diameter and the second inner diameter.

2. The cylindrical permanent magnetic coupling device of claim 1, wherein the cavity has an opening, and the first inner diameter near the bottom is smaller than the second inner diameter near the opening.

3. The cylindrical permanent magnetic coupling device of claim 1, wherein the conductor rotor is connected to a motor, and the permanent magnet rotor is connected to a load.

4. The cylindrical permanent magnetic coupling device of claim 1, wherein the conductor rotor comprises:
a magnetic cylinder comprising the bottom and the sidewall; and
a conductor ring located on an inner surface of the sidewall.

5. The cylindrical permanent magnetic coupling device of claim 4, wherein the magnetic cylinder is made of low carbon steel or a silicon steel plate.

6. The cylindrical permanent magnetic coupling device of claim 4, wherein the conductor ring is made of copper, aluminum or a Fe—Cu alloy.

7. The cylindrical permanent magnetic coupling device of claim 4, wherein the sidewall comprises a base near the bottom, and an extending portion connected to the base, wherein an inner diameter of the base is smaller than an inner diameter of the extending portion.

8. The cylindrical permanent magnetic coupling device of claim 7, wherein axial cross-sectional profiles of the base and the extending portion are rectangles.

9. The cylindrical permanent magnetic coupling device of claim 7, wherein an axial cross-sectional profile of the base is a rectangle, an axial cross-sectional profile of the extending portion is a trapezoid, and an inner diameter of the extending portion increases gradually in the direction from the base to the extending portion.

10. The cylindrical permanent magnetic coupling device of claim 7, wherein axial cross-sectional profiles of the base and the extending portion are trapezoids.

11. The cylindrical permanent magnetic coupling device of claim 7, wherein an axial cross-sectional profile of the extending portion is a rectangle, an axial cross-sectional profile of the base is a trapezoid, and an inner diameter of the base increases gradually in the direction from the bottom to an opening.

12. The cylindrical permanent magnetic coupling device of claim 7, wherein an axial length of the base is greater than an axial length of the permanent magnet rotor, and an axial length of the extending portion is greater than the axial length of the permanent magnet rotor.

13. The cylindrical permanent magnetic coupling device of claim 1, wherein the permanent magnet rotor comprises a magnetic ring, and a plurality of permanent magnets disposed on a side of the magnetic ring.

14. The cylindrical permanent magnetic coupling device of claim 1, wherein each of the air gaps is greater than or equal to 4 mm.
